(19) United States
(12) Patent Application Publication
(10) Pub. No.: US 2018/0038817 A1
(43) Pub. Date: Feb. 8, 2018

(54) SENSOR

(71) Applicant: ISUZU MOTORS LIMITED, Tokyo (JP)

(72) Inventors: Tadashi UCHIYAMA, Kamakura-shi, Kanagawa (JP); Naoto MURASAWA, Yamato-shi, Kanagawa (JP)

(73) Assignee: Isuzu Motors Limited, Tokyo (JP)

(21) Appl. No.: 15/552,244

(22) PCT Filed: Feb. 17, 2016
(86) PCT No.: PCT/JP2016/054619

§ 371 Date: Aug. 18, 2017

(30) Foreign Application Priority Data
Feb. 20, 2015 (JP) 2015-031525

(51) Int. Cl. G01N 27/22; F01N 3/022

(52) U.S. Cl. CPC G01N 27/226; F01N 3/022; F01N 2560/028; F01N 2560/05; G01M 15/102

(57) ABSTRACT

There is provided a sensor unit 30 arranged in an exhaust system of an internal combustion engine and including a filter member 31 having a plurality of cells divided by porous partition walls and collecting particulate matter in exhaust gas, and at least one pair of electrode members 32, 33 arranged to face each other with the cell interposed therebetween so as to form a capacitor, and a control unit 40 estimating an amount of the particulate matter in the exhaust gas and detecting water present in the exhaust system of the engine, based on an electrostatic capacitance between the pair of electrode members 32, 33.

### TECHNICAL FIELD

The present invention relates to a sensor for detecting an amount of particular matter (hereinafter, referred to as PM) contained in exhaust gas.

### BACKGROUND ART

Sensors for detecting an amount of PM contained in exhaust gas to be discharged from an internal combustion engine are known. As the sensors, a sensor is also known, in which sensor electrode portions are arranged in an exhaust pipe and PM is detected based on an electrostatic capacitance change amount occurred as the PM is adhered on the sensor electrode portions (e.g., see Patent Reference 1).

In the sensor, determination on failure of the sensor is performed using a change in peak shape of an electrostatic capacitance appearing if condensate water, which is created by condensation of moisture contained in exhaust gas, is adhered on the sensor electrode portions.

### PRIOR ART REFERENCE

### Patent Reference

Patent Document 1: JP-A-2010-275917

### DISCLOSURE OF THE INVENTION

### Problems to be Solved

In terms of protection of various sensors and the like, it is preferable to reliably detect the condensate water. Also, water is likely to be infiltrated into the exhaust system of the internal combustion engine from the outside, and for the same reason, it is preferable to reliably detect water infiltrated from the outside. However, the sensor as described above is configured to determine a failure of the sensor itself and thus does not take into account detection of water present in the exhaust system of the internal combustion engine, such as condensate water or water infiltrated from the outside.

An object of the present disclosure is to provide a sensor in which it is possible to detect water present in the exhaust system of the internal combustion engine.

### Means for Solving the Problems

A sensor according to the present disclosure includes: a sensor unit arranged in an exhaust system of an internal combustion engine and including: a filter member having a plurality of cells divided by porous partition walls and collecting a particulate matter in exhaust gas, and at least one pair of electrode members arranged to face each other with the cell interposed therebetween so as to form a capacitor and a controller estimating an amount of the particulate matter in the exhaust gas and detecting water present in the exhaust system of the internal combustion engine, based on an electrostatic capacitance between the pair of electrode members.

Further, a sensor according to the present disclosure includes: a sensor unit arranged in an exhaust system of an internal combustion engine and including: a filter member having a plurality of cells divided by porous partition walls and collecting a particulate matter in exhaust gas, and at least one pair of electrode members arranged to face each other with the cell interposed therebetween so as to form a capacitor, and a control unit, wherein the control unit is operated to execute an estimating process of estimating an amount of the particulate matter in the exhaust gas based on an electrostatic capacitance between the pair of electrode members; and a detecting process of detecting water present in the exhaust system of the internal combustion engine based on the electrostatic capacitance between the pair of electrode members.

### Advantageous Effects of Invention

According to the sensor of the present disclosure, it is possible to detect water present in the exhaust system of the internal combustion engine.

### BRIEF DESCRIPTION OF DRAWINGS

FIG. 1 is a schematic configuration view showing an example of an exhaust system to which a PM sensor of a first embodiment is applied.

FIG. 2 is a schematic partially sectional view showing the PM sensor of the first embodiment.

FIG. 3A is a partially enlarged sectional view explaining collecting of PM.

FIG. 3B is a partially enlarged sectional view explaining a water-infiltrated state.

FIG. 4A is a chart explaining a change over time in electrostatic capacitance change amount of a PM sensor as an amount of PM is increased.

FIG. 4B is a chart explaining a change over time in electrostatic capacitance change amount of the PM sensor due to water infiltration.

FIG. 4C is a chart explaining a change over time in electrostatic capacitance in a case where water infiltration is occurred while PM is being collected.

FIG. 5 is a schematic partially sectional view showing a PM sensor of a second embodiment.

FIG. 6A is a schematic perspective view of each of sensor units according to a third embodiment.

FIG. 6B is a schematic exploded perspective view of each of sensor units according to the third embodiment.

### MODE FOR CARRYING OUT THE INVENTION

Hereinafter, sensors according to respective embodiments of the present invention will be described with reference to the accompanying drawings. The same components will be designated by the same reference numerals, and the names and functions thereof are the same. Therefore, the detailed descriptions thereof will not be repetitively made.

### First Embodiment

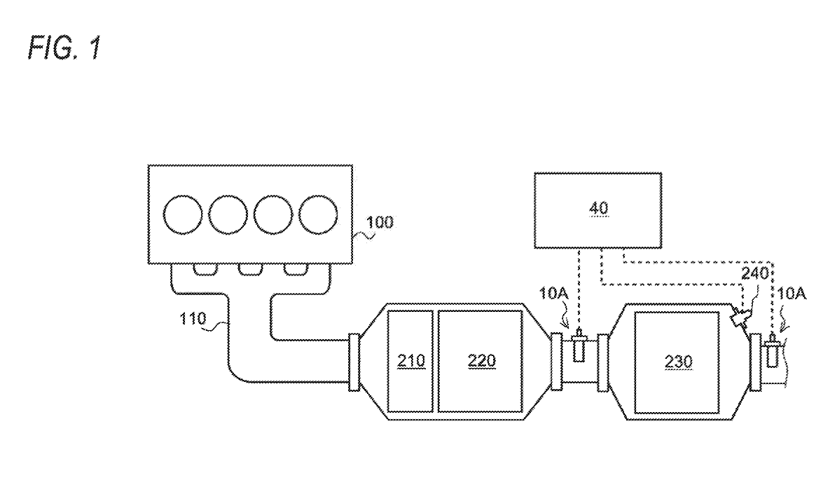

FIG. 1 is a schematic configuration view showing an example of an exhaust system of a diesel engine (hereinafter, simply referred to as engine) 100, to which a PM sensor 10A according to the first embodiment are applied. In an exhaust pipe 110 of the engine 100, an oxidation catalyst 210, a diesel particulate filter (DPF, hereinafter, simply also referred to as filter) 220, a NOx purification catalyst 230, a NOx/lambda sensor 240 and the like are provided in this order from an upstream side in an exhaust direction.

The oxidation catalyst 210 is configured to oxidize unburned fuel (hydrocarbon (HC)) and to increase a temperature of the exhaust gas when the unburned fuel is supplied thereto. The filter 220 is formed so that a plurality of cells divided by porous partition walls are arranged along exhaust gas flow direction and are alternately plugged at upstream and downstream sides of the cells. The filter 220 is configured so that PM in the exhaust gas is collected by micro-holes or surfaces of the partition walls and if an estimated amount of PM accumulated thereon reaches a predetermined amount, a so-called filter forced regeneration of combusting and removing the accumulated PM thereon is executed. The filter forced regeneration is performed, for example, by supplying unburned fuel to the oxidation catalyst 210 upstream of the filter 220 and thus increasing a temperature of the exhaust gas to be introduced into the filter 220 to a PM combustion temperature. The NOx purification catalyst 230 is configured to reduce and purify NOx in the exhaust gas, and the NOx/lambda sensor 240 is configured to detect a NOx concentration and excess air ratio in the exhaust gas. The PM sensor 10A of the present embodiment is provided in the exhaust pipe 110, for example, downstream of the DPF 220 and also upstream of the NOx purification catalyst 230, but may be provided in the exhaust pipe 110 downstream of the NOx purification catalyst 230.

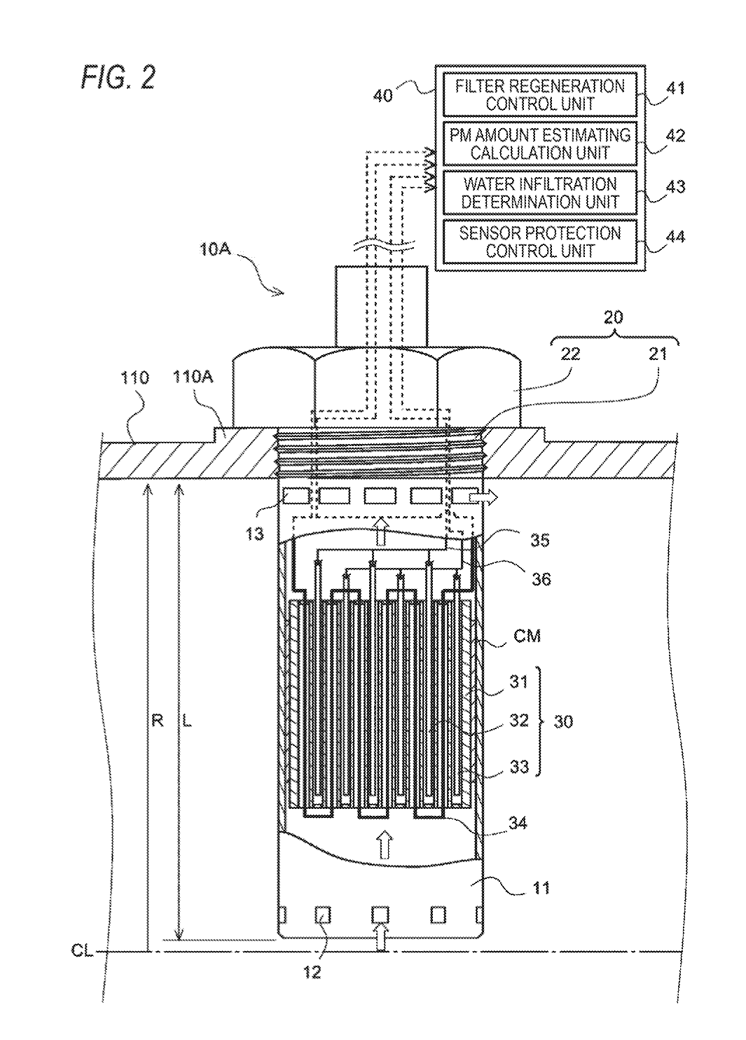

Next, the detailed configuration of the PM sensor 10A according to the first embodiment will be described with reference to FIG. 2. The PM sensor 10A includes a case member 11 inserted in the exhaust pipe 110, a pedestal portion 20 configured to attach the case member 11 to the exhaust pipe 110, a sensor unit 30 accommodated in the case member 11 and a control unit 40.

The case member 11 has a shape of a bottomed cylinder, of which a bottom side (a lower end side in the shown example) is closed. A length L of the case member 11 in a cylinder axis direction is substantially the same as a radius R of the exhaust pipe 110 so that a cylindrical wall portion at the bottom side protrudes to a location near to a center axis CL of the exhaust pipe 110. Meanwhile, in the following descriptions, the bottom side of the case member 11 is referred to as a distal end side, and an opposite side to the bottom side is referred to as a base end side of the case member 11.

A cylindrical wall portion of the case member 11 at the distal end side is provided with a plurality of inflow ports 12 arranged to be spaced from each other in a circumferential direction. Also, a cylindrical wall portion of the case member 11 at the base end side is provided with a plurality of outflow ports 13 arranged to be spaced from each other in the circumferential direction. A total opening area S₁₂ of the inflow ports 12 is smaller than a total opening area S₁₃ of the outflow ports 13 (S₁₂<S₁₃). That is, an exhaust flow velocity V₁₂ in the vicinity of the inflow ports 12 becomes slower than an exhaust flow velocity V₁₃ in the vicinity of the outflow ports 13 (V₁₂<V₁₃), so that a pressure P₁₂ at the inflow ports 12 becomes higher than a pressure P₁₃ at the outflow ports 13 (P₁₂>P₁₃). Thus, the exhaust gas smoothly flows into the case member 11 through the inflow ports 12, and the exhaust gas in the case member 11 smoothly flows out through the outflow ports 13 into the exhaust pipe 110.

The pedestal portion 20 has a male screw portion 21 and a nut portion 22. The male screw portion 21 is provided on a base end portion of the case member 11 and is configured to close an opening of the case member 11 at the base end side. The male screw portion 21 is screwed with a female screw portion of a boss portion 110A formed on the exhaust pipe 110. The nut portion 22 is, for example, a hexagonal nut and is fixed to an upper end portion of the male screw portion 21. The male screw portion 21 and the nut portion 22 have through-holes (not shown) formed therein, through which conductive wires 35, 36 and the like as described below are to be inserted.

The sensor unit 30 has a filter member 31, a plurality of pairs of electrode members 32, 33, and an electrical heater 34.

The filter member 31 is formed so that a plurality of cells, which form lattice-shaped exhaust flow paths divided by partition walls of, for example, porous ceramics, are alternately plugged at upstream and downstream sides thereof. The filter member 31 is held on an inner peripheral surface of the case member 11 via a cushion member CM in a state where a flow path direction of the cells is arranged to be substantially parallel to an axial direction (an upward and downward direction in the figure) of the case member 11.

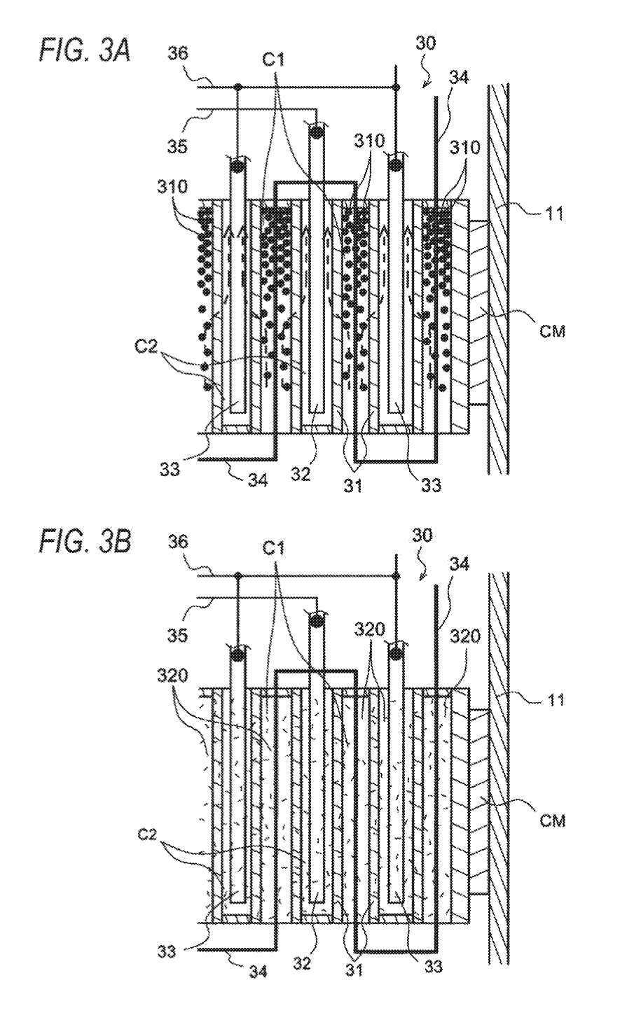

As enlargedly shown in FIG. 3A, PM 310 in the exhaust gas introduced in the case member 11 through the inflow ports 12 is collected by surfaces or micro-holes of partition walls as the exhaust gas flows from cells C1 plugged at the downstream side thereof into cells C2 plugged at the upstream side thereof as shown by broken line arrows. Meanwhile, in the following description, the cell plugged at the downstream side thereof is referred to as a measurement cell C1 and the cell plugged at the upstream side thereof is referred to as an electrode cell C2.

As shown in FIG. 2, the electrode members 32, 33 are, for example, conductive metal wires and are alternately inserted into the electrode cells C2, which face each other with the measurement cell C1 interposed therebetween, from the downstream side (unplugged side) thereof, thereby forming a capacitor. The electrode members 32, 33 are respectively connected to an electrostatic capacitance detection circuit (not shown) embedded in the control unit 40, via the conductive wires 35, 36.

The electrical heater 34 is, for example, an electric heating wire and is configured to generate heat by being energized and thus to directly heat the sensor filter 31, thereby executing a so-called filter regeneration of combusting and removing the PM accumulated in the measurement cells C1. Accordingly, the electrical heater 34 is formed to be bent into a continuous S-shape, and linear portions thereof parallel to each other are inserted in the respective measurement cells C1 along the flow paths thereof.

The control unit 40 is an example of the controller of the present invention and has a filter regeneration control unit 41, a PM amount estimating calculation unit 42, a water infiltration determination unit 43 and a sensor protection control unit 44 as individual functional elements. The functional elements are described as being contained in the control unit 40, which is a unitary hardware, but may be provided in separate hardware.

The filter regeneration control unit 41 is configured to determine whether or not a filter regeneration condition is satisfied, based on an electrostatic capacitance Cp between the electrode members 32, 33, which is detected by an electrostatic capacitance detection circuit (not shown), and then to execute filter regeneration control of turning on (energizing) the electrical heater 34 in a case where the filter regeneration condition is satisfied. The electrostatic capacitance Cp between the electrode members 32, 33 is expressed by the following equation 1, where ∈ is a dielectric constant of a medium between the electrode members 32, 33, S is a surface area of the electrode members 32, 33, and d is a distance between the electrode members 32, 33.

$$\begin{matrix}[ Equation 1 ] & \\ Cp = Σ ( ɛ \times \frac{S}{d} ) & ( 1 )\end{matrix}$$

In the equation 1, the surface area S of the electrode members 32, 33 is constant, and when the dielectric constant s and the distance d are changed by the PM collected in the measurement cells C1, the electrostatic capacitance Cp is correspondingly changed. That is, the electrostatic capacitance Cp between the electrode members 32, 33 and an amount of the PM accumulated in the sensor filter 31 have a proportional relation.

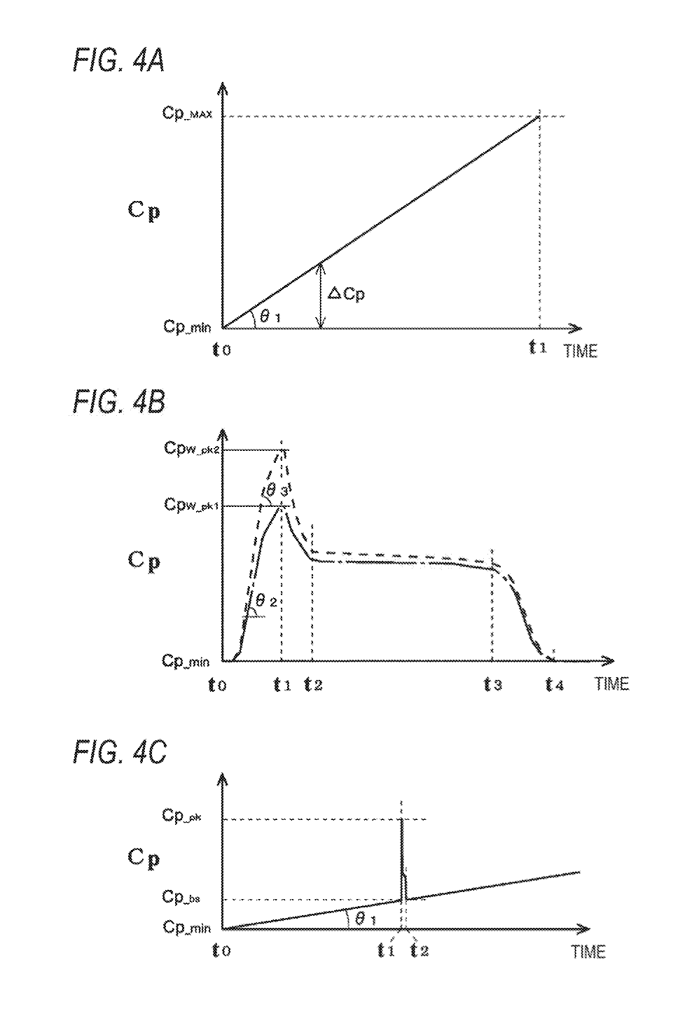

In the example shown in FIG. 4A, the electrostatic capacitance between Cp the electrode member 32, 33 is increased at a change amount per unit time θ₁ (ΔCp/Δt) as the PM is accumulated in the measurement cells C1. If the electrostatic capacitance Cp reaches a predetermined electrostatic capacitance upper threshold C_{P}_{_}ₘₐₓ, which indicates an upper limit amount of the accumulated PM, the filter regeneration control unit 41 determines that the filter regeneration condition is satisfied and thus starts filter regeneration of turning on the electrical heater 34. The filter regeneration continues until the electrostatic capacitance Cp is lowered to a predetermined electrostatic capacitance lower threshold C_{P}_{_}ₘᵢₙ, which indicates that the PM is completely removed.

The PM amount estimating calculation unit 42 is configured to estimate a total PM amount m_{PM} in the exhaust gas discharged from the filter 220, based on an electrostatic capacitance change amount ΔCp of the PM sensor 10A during a regeneration interval period (from the end of the filter regeneration to the start of the next filter regeneration). The PM amount m_{PM} collected in the filter member 31 during the regeneration interval period is obtained by the following equation 2, in which the electrostatic capacitance change amount ΔCp of the PM sensor 10A is multiplied by a linear coefficient β.

[Equation 2]

m_{PM}=β·ΔCp (2)

The water infiltration determination unit 43 is configured to determine whether or not water is present in the exhaust system, based on a peak value of the electrostatic capacitance Cp or an electrostatic capacitance change amount per unit time θ (ΔCp/Δt) of the PM sensor 10A. Then, when water is present in the exhaust system, the water infiltration determination unit 43 is configured to estimate an amount of the water.

If water is present in the exhaust system, as shown in FIG. 3B, some of the water is held in the filter member 31. Specifically, the water is held in the measurement cells C1 and electrode cells C2 equipped in the filter member 31. Since the measurement cells C1 and electrode cells C2 are a lattice-shaped elongated space, the water 320 is smoothly introduced and held in each of the cells C1, C2.

If the water 320 is held in the filter member 31, the peak value of the electrostatic capacitance Cp in the PM sensor 10A is significantly higher than that of a case where PM is accumulated therein, and also the electrostatic capacitance change amount θ until reaching the peak value is steeper (greater in gradient) than that of the case where PM is accumulated therein. Further, as an amount of water 320 held in the filter member 31 is increased, the peak value of the electrostatic capacitance Cp becomes higher, and also as the amount of water 320 held in the filter member 31 is increased, the electrostatic capacitance change amount per unit time θ (ΔCp/Δt) becomes steeper.

As shown by a one-dot chain line in FIG. 4B, if a certain amount of water 320 is held in the filter member 31, the electrostatic capacitance Cp is increased at a change amount θ₂, which is significantly steeper than a change amount θ₁ of the case when PM is accumulated therein, during a period until the electrostatic capacitance Cp reaches a peak value C_{pw}_{_}ₚₖ₁ (times t₀ to t₁). As shown by a broken line in FIG. 4B, if more water 320 is held in the filter member 31, the electrostatic capacitance Cp is increased at a change amount θ₃, which is even steeper than the change amount θ₂, until reaching a peak value Cp_{w}_{_}ₚₖ₂. In both the cases, if the water 320 is evaporated from the filter member 31 due to flowing of exhaust gas therethrough, the electrostatic capacitance Cp is decreased to Cₚ_{_}ₘᵢₙ (times t₃ to t₄).

Therefore, the water infiltration determination unit 43 determines that water 320 is present in the exhaust system, if at least one of determination conditions, including a case where the peak value Cp_{w}_{_}ₚₖ of the electrostatic capacitance is equal to or higher than a predetermined upper threshold and a case where the change amount θ in the electrostatic capacitance Cp is equal to or greater than a predetermined upper threshold is satisfied. Also, the water infiltration determination unit 43 determines an amount of water present based on a value of the peak value Cp_{w}_{_}ₚₖ of the electrostatic capacitance. Determining the amount of water can be performed, for example, by using a map for determination. The map can be created by changing an amount of water held in the filter member 31 and then measuring a corresponding peak value Cp_{w}_{_}ₚₖ of the electrostatic capacitance.

FIG. 4C shows an example of a case where water is infiltrated from the outside while PM is being collected. As shown in FIG. 4C, the electrostatic capacitance Cp is increased at a change amount θ₁ corresponding to an amount of accumulated PM during a period from time t₀ to time t₁. Thereafter, the electrostatic capacitance is steeply increased from Cp_{—bs} to Cp_{—pk} at the time t₁ and then returns to Cp_{—bs} at a time t₂, and then based thereon, the water infiltration determination unit 43 determines that during a period from time t₁ to time t₂, the predetermined determination condition is satisfied and thus water 320 is infiltrated into the exhaust system from the outside.

The sensor protection control unit 44 is configured to protect various sensors by prohibiting energization to the sensors, when the water infiltration determination unit 43 determines that water is present in the exhaust system. In the present embodiment, the sensor protection control unit 44 protects the NOx/lambda sensor 240 by prohibiting energization to a heater (not shown) equipped in the NOx/lambda sensor 240.

As such, the water infiltration determination unit 43 can detect water (condensate water or infiltrated water) present in the exhaust system of the engine 100, based on the change amount per unit time θ (ΔCp/ΔT) in electrostatic capacitance Cp between the electrode members 32, 33 or the peak value Cp_{—pk}, thereof. In this way, since water is detected based on the electrostatic capacitance Cp between the electrode members 32, 33, water present in the exhaust system can be detected. In addition, detection of water is performed by the PM sensor 10A, which is intended to detect an amount of PM. That is, the PM sensor 10A is used both for detecting an amount of PM and for detecting water present in the exhaust system. Accordingly, it is unnecessary to separately provide a dedicated sensor, thereby achieving a simplified configuration.

Further, the sensor protection control unit 44 prohibits energization to various sensors during a period in which the water infiltration determination unit 43 is determining that water is present in the exhaust system. Therefore, the various sensors can be protected.

### Second Embodiment

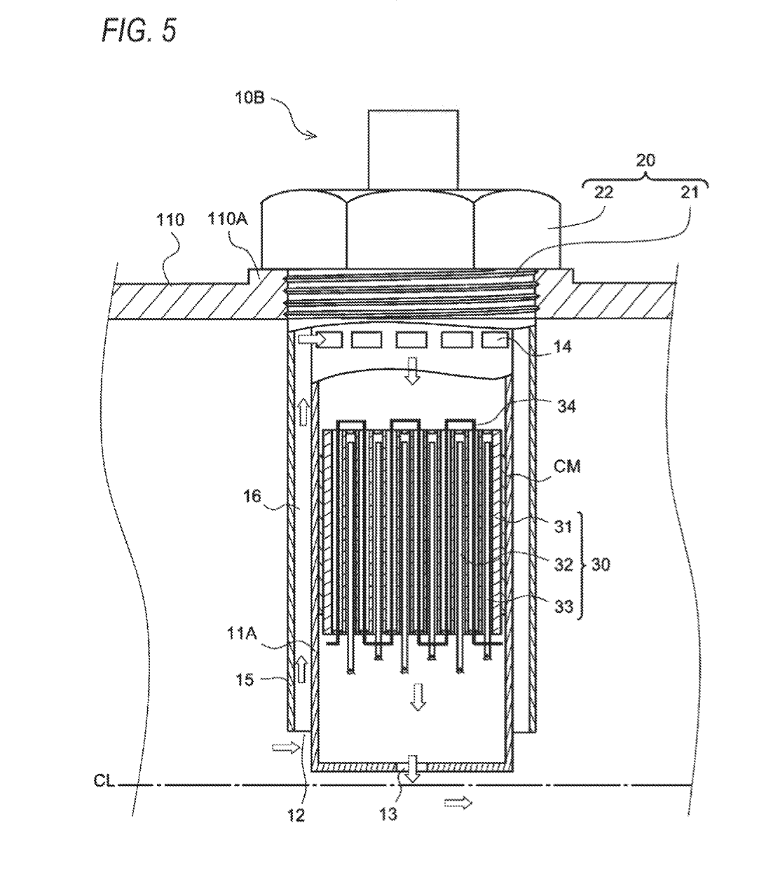

Next, a PM sensor 10B according to the second embodiment will be described in detail with reference to FIG. 5. The PM sensor 10B of the second embodiment is configured so that the case member in the PM sensor 10A of the first embodiment has a double pipe structure. The other components have the same structures, and accordingly the detailed descriptions thereof will be omitted. Also, some components, such as the control unit 40 and the like, are not shown.

The case member of the second embodiment has a cylindrical bottomed inner case portion 11A and a cylindrical outer case portion 15 surrounding a cylindrical outer peripheral surface of the inner case portion 11A.

The inner case portion 11A is formed to have an axial length greater than that of the outer case portion 15 so that a distal end side thereof protrudes relative to the outer case portion 15. Also, a bottom portion of the inner case portion 11A is provided with an outflow port 13 for allowing exhaust gas in the inner case portion 15 to flow into an exhaust pipe 110. Further, a cylindrical wall portion of the inner case portion 11A at a base end side thereof is provided with a plurality of passage ports 14 arranged to be spaced with each other in a circumferential direction. The passage ports 14 are configured to allow exhaust gas in a flow path 16 defined between an outer peripheral surface of the inner case portion 11A and an inner peripheral surface of the outer case portion 15 to flow into the inner case portion 11A.

On a downstream end of the flow path 16, a circular ring-shaped inflow port 12 defined between the cylindrical wall portion of the inner case portion 11A at the distal end side thereof and the distal end portion of the outer case portion 15 is formed. An opening area S₁₂ of the inflow port 12 is formed to be smaller than an opening area S₁₃ of the outflow port 13 (S₁₂<S₁₃).

That is, the exhaust gas flowing through the exhaust pipe 110 collides with the cylindrical wall surface of the inner case portion 11A protruding distally relative to the outer case portion 15 and thus is smoothly introduced into the flow path 16 through the inflow port 12 arranged near to a center axis CL of the exhaust pipe 110. Then, the exhaust gas flowing through the flow path 16 is introduced into the inner case portion 11 through the passage ports 14, passes through the filter member 31, and then smoothly flows out through the outflow port 13 arranged near to the center axis CL of the exhaust pipe 110 into the exhaust pipe 110. As such, in the PM sensors 10B of the second embodiment, the inflow port 12 and the outflow port 13 are arranged near to the center axis CL where an exhaust flow velocity is highest in the exhaust pipe 110, so that it is possible to effectively increase a flow rate of the exhaust gas passing through the sensor filter 31.

### Third Embodiment

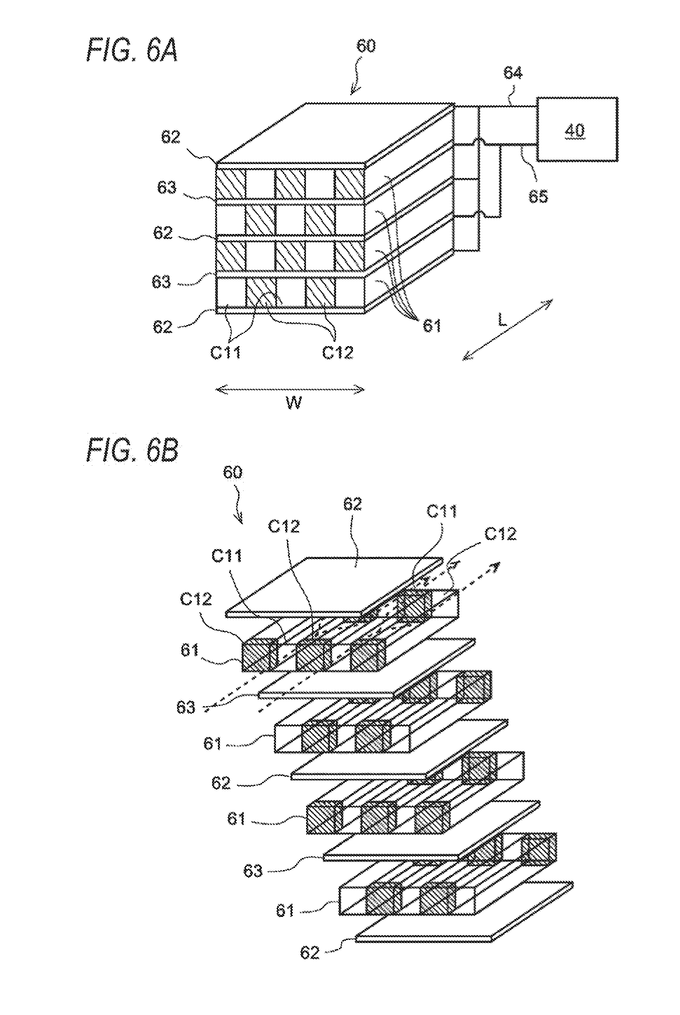

Next, a PM sensor according to the third embodiment will be described in detail with reference to FIG. 6. The PM sensor of the third embodiment is configured so that the sensor unit 30 of the first embodiment is a stack type. The other components have the same structures, and accordingly the detailed descriptions and illustrations thereof will be omitted.

FIG. 6A is a perspective view of the sensor unit 60 of the third embodiment and FIG. 6B is an exploded perspective view of the sensor unit 60. The sensor unit 60 has a plurality of filter layers 61 and a plurality of electrode plates 62, 63.

The filter layer 61 is formed so that a plurality of cells, which are divided by partition walls of, for example, porous ceramics or the like and form exhaust flow paths, are alternately plugged at upstream and downstream sides thereof and the cells are arranged in parallel in one direction in a cuboid shape. PM contained in the exhaust gas is collected by surfaces or micro-holes of the partitions walls of the cells C11 as the exhaust gas flows from the cells C11 plugged at the downstream side thereof into the cells C12 plugged at the upstream side thereof as shown by broken line arrows in FIG. 6B. Meanwhile, in the following description, a flow path direction of the cells is referred to as a longitudinal direction (an arrow L in FIG. 6A) of the sensor unit 60, and a direction perpendicular to the flow path direction of the cells is referred to as a width direction (an arrow W in FIG. 6A) of the sensor unit 60.

The pair of electrode plates 62, 63 are conductive members having, for example, a flat plate shape, and external dimensions thereof in the longitudinal direction L and the width direction W are substantially the same as those of the filter layer 61. The pair of electrode plates 62, 63 are alternately stacked with the filter layer 61 interposed therebetween and are respectively connected to an electrostatic capacitance detection circuit (not shown) embedded in the control unit 40 via conductive wires 64, 65.

That is, the pair of electrode plates 62, 63 are arranged to face each other and the filter layer 61 are interposed between the electrode plates 62, 63, so that the entire cells C11 form a capacitor. As such, in the PM sensor of the third embodiment, the entire cells C11 are configured as the capacitor due to the electrode plates 62, 63 having a flat plate shape, so that it is possible to effectively secure an electrode surface area S and to increase an absolute value of a detectable electrostatic capacitance. Also, the distance d between the electrodes corresponds to a pitch of the cells and is uniform, so that it is possible to effectively suppress the non-uniformity of an initial electrostatic capacitance.

Meanwhile, when combusting and removing the PM accumulated in the cells C11, a voltage may be directly applied to the electrode plates 62, 63 or a heater board or the like (not shown) may be provided between the filter layer 61 and the electrode plates 62, 63.

[Others]

The present invention is not limited to the foregoing embodiments and changes thereof can be appropriately made without departing from the spirit and scope of the present invention.

This application is based on Japanese Patent Application No. 2015-031525 filed on Feb. 20, 2015, the entire contents of which are incorporated herein by reference.

### INDUSTRIAL APPLICABILITY

The sensor of the present invention has the effect that it is possible to detect water present in an exhaust system of an internal combustion engine and thus is useful in that sensors therein can be protected.

### REFERENCE SIGNS LIST

10A, 10B PM sensor
11 Case member
12 Inflow port
13 Outflow port
20 Pedestal portion
21 Male screw portion
22 Nut portion
30 Sensor unit
31 Filter member
32, 33 Electrode member
34 Electrical heater
40 Control unit
41 Filter regeneration control unit
42 PM amount estimating calculation unit
43 Water infiltration determination portion
44 Sensor protection control unit

1. A sensor comprising:
a sensor unit arranged in an exhaust system of an internal combustion engine and including: a filter member having a plurality of cells divided by porous partition walls and collecting particulate matter in exhaust gas; and at least one pair of electrode members arranged to face each other with the cell interposed therebetween so as to form a capacitor; and
a controller estimating an amount of the particulate matter in the exhaust gas and detecting water present in the exhaust system of the internal combustion engine, based on an electrostatic capacitance between the pair of electrode members.

2. The sensor according to claim 1,
wherein the controller estimates the amount of the particulate matter in the exhaust gas based on an electrostatic capacitance change amount between the pair of electrode members and detects the water present in the exhaust system of the internal combustion engine based on at least one of an electrostatic capacitance change amount per unit time between the pair of electrode members and a peak value of the electrostatic capacitance.

3. The sensor according to claim 1,
wherein the filter member is a filter layer in which the plurality of cells are arranged in parallel in one direction, and
wherein the pair of electrode members is a pair of flat plate-shaped electrodes arranged to face each other with the filter layer interposed therebetween.

4. A sensor comprising:
a sensor unit arranged in an exhaust system of an internal combustion engine and including: a filter member having a plurality of cells divided by porous partition walls and collecting particulate matter in exhaust gas; and at least one pair of electrode members arranged to face each other with the cell interposed therebetween so as to form a capacitor; and
a control unit
wherein the control unit is operated to execute:
an estimating process of estimating an amount of the particulate matter in the exhaust gas based on an electrostatic capacitance between the pair of electrode members; and
a detecting process of detecting water present in the exhaust system of the internal combustion engine based on the electrostatic capacitance between the pair of electrode members.

5. The sensor according to claim 4,
wherein the estimating process includes estimating the amount of the particulate matter in the exhaust gas based on an electrostatic capacitance change amount between the pair of electrode members, and
wherein the detecting process includes detecting the water present in the exhaust system of the internal combustion engine based on at least one of an electrostatic capacitance change amount per unit time between the pair of electrode members and a peak value of the electrostatic capacitance.

6. The sensor according to claim 4,
wherein the filter member is a filter layer in which the plurality of cells are arranged in parallel in one direction, and
wherein the pair of electrode members is a pair of flat plate-shaped electrodes arranged to face each other with the filter layer interposed therebetween.
